(19) United States
(12) Patent Application Publication
(10) Pub. No.: US 2002/0047968 A1
(43) Pub. Date: Apr. 25, 2002

(54) Liquid crystal display device

(76) Inventors: Keisuke Yoshida, Yamatokooriyama-shi (JP); Makoto Shiomi, Tenri-shi (JP)

Correspondence Address: NIXON & VANDERHYE P.C., 8th Floor, 1100 North Glebe Rd., Arlington, VA, 22201-4714, US

(21) Appl. No.: 09/905,880

(22) Filed: Jul. 17, 2001

(30) Foreign Application Priority Data
Aug. 28, 2000 (JP) 2000-256870

(51) Int. Cl. G02F 1/1335

(52) U.S. Cl. 349/117

(57) ABSTRACT

The liquid crystal display device includes: a liquid crystal cell including a horizontal orientation liquid crystal layer that includes liquid crystal molecules having a positive dielectric anisotropy; a pair of polarizing plates provided outside the liquid crystal cell; and at least one first phase compensation element provided between the liquid crystal cell and the pair of polarizing plates, and the liquid crystal display device provides display in a normally white mode. The liquid crystal layer has first and second liquid crystal regions in every picture element. The first and second liquid crystal regions have their respective orientation-axis directions forming an angle of 170° to 190° with each other. The orientation-axis directions are defined by an azimuth of an orientation direction of the liquid crystal molecules located in a center of the liquid crystal layer in a thickness direction. The first phase compensation element compensates for a retardation of the liquid crystal layer in a black display state with respect to vertical incident light on the liquid crystal layer.

### BACKGROUND OF THE INVENTION

1. Field of the Invention

The present invention generally relates to a liquid crystal display device (LCD). More particularly, the present invention relates to an LCD having excellent viewing-angle characteristics.

2. Description of the Background Art

With development of information infrastructure, television display devices and office-automation personal computer monitors (OA PC monitors) serving as video and audio information terminals have been increasingly developed. In particular, it is expected from the social needs for spaceand power-saving that the LCDs will be increasingly applied to medium- or small-size televisions and OA PC monitors. In order to meet the marketing needs, the LCDs must have a low driving voltage, high contrast ratio and fast response. In order to realize these characteristics, a display mode using a liquid crystal layer including uniformly oriented liquid crystal molecules is preferred. The currently most widely used TN (Twisted Nematic) and STN (Super Twisted Nematic) modes correspond to this display mode.

However, the liquid crystal molecules are highly uniformly oriented in the TN and STN modes. Therefore, the display quality such as contrast ratio and color varies depending on a viewing angle due to the refractive index anisotropy of the individual liquid crystal molecules, hindering the use of the LCDs in applications other than the personal applications.

In order to solve this problem, various display modes have been proposed, including: (1) an IPS (In-Plane Switching) mode in which the liquid crystal molecules are moved in parallel with the substrate surface by using a transverse electric field; (2) a mode in which the liquid crystal molecules having a negative dielectric anisotropy are initially oriented approximately vertically to the substrate surface, and a picture element is formed from the regions having different tilt directions of the liquid crystal molecules in the presence of an applied voltage (MVA (Multi-domain Vertical Alignment) mode; e.g., Japanese Laid-Open Publication No. 7-28068); and (3) a mode in which the liquid crystal molecules are oriented approximately horizontally to the substrate surface in the absence of an applied voltage, and the regions where the liquid crystal molecules are raised in different directions in response to application of a voltage are formed in order to widen the viewing angle (Japanese Laid-Open Publication No. 10-3081).

However, these conventional modes are not satisfactory in terms of, e.g., characteristics and costs.

For example, the IPS mode and the MVA mode have excellent viewing-angle characteristics, but have a narrower design margin of the liquid crystal cell as compared to the TN mode, causing reduced yield as well as increased costs. In order to cope with ever-increasing display information density such as digital broadcasting and DVDs (Digital Video Discs), a wide viewing angle as well as rapid response achieving excellent moving-picture performance are required. The IPS mode has excellent viewing-angle characteristics, but has poor response.

Although attempts have been made to improve the viewing-angle characteristics of the TN mode by using a phase compensation element, no satisfactory result have been obtained. For example, the TN mode has the following voltage-transmittance characteristics in a NW (Normally White) mode: in a regular viewing-angle direction (the viewing-angle direction tilted from the direction normal to the display plane (frontal direction) along the orientation direction of the liquid crystal molecules in an intermediate gray-scale display state), the transmittance rises with increase in applied voltage, causing gray-scale inversion of the displayed image (hereinafter, referred to as a “gray-scale inversion phenomenon”). Whatever phase compensation element is used, this gray-scale inversion phenomenon in the TN mode cannot completely be prevented. In the regular viewing-angle direction, the transmittance starts decreasing at a voltage lower than that in the frontal direction, reaches the minimum value at a voltage lower than that in the frontal direction, and then rises again. Therefore, the display becomes blackish as a whole. In the opposite viewing-angle direction (the direction opposite to the regular viewing-angle direction), the transmittance does not sufficiently decrease at the voltage of a substantially minimum transmittance in the frontal direction. Therefore, the display becomes whitish as a whole. It is also impossible to improve the viewing-angle dependency of the display quality in the TN mode by using a phase compensation element.

### SUMMARY OF THE INVENTION

The present invention is made in view of the foregoing problems, and it is an object of the present invention to provide a liquid crystal display device having improved viewing-angle characteristics over a conventional TN mode LCD, having a high response speed, and also capable of being produced at relatively low costs.

A liquid crystal display device of the present invention includes: a liquid crystal cell including a pair of substrates, and a horizontal orientation liquid crystal layer provided between the pair of substrates and including liquid crystal molecules having a positive dielectric anisotropy, the liquid crystal cell having a plurality of picture elements, the picture elements each being defined by a pair of electrodes facing each other with the liquid crystal layer interposed therebetween; a pair of polarizing plates provided outside the liquid crystal cell; and at least one first phase compensation element provided between the liquid crystal cell and the pair of polarizing plates, the liquid crystal display device providing display in a normally white mode, wherein each of the plurality of picture elements has first and second liquid crystal regions having their respective orientation-axis directions forming an angle of 170° to 190° with each other, the orientation-axis directions being defined by an azimuth of an orientation direction of the liquid crystal molecules located in a center of the liquid crystal layer in a thickness direction, and the at least one first phase compensation element compensates for a retardation of the liquid crystal layer in a black display state with respect to vertical incident light on the liquid crystal layer. Thus, the aforementioned object is achieved.

In one embodiment, the pair of polarizing plates are arranged such that their respective absorption axes are perpendicular to each other, and the at least one first phase compensation element has a slow axis within a plane parallel with the liquid crystal layer and is arranged such that the slow axis is approximately perpendicular to the respective orientation-axis directions of the first and second liquid crystal regions.

Preferably, the liquid crystal display device further includes at least one second phase compensation element between the pair of polarizing plates and the liquid crystal cell, the at least one second phase compensation element having a fast axis in a direction normal to the liquid crystal layer.

Preferably, the at least one second phase compensation element is provided between the at least one first phase compensation element and the pair of polarizing plates.

Preferably, the at least one first phase compensation element is a pair of first phase compensation elements arranged so as to face each other with the liquid crystal cell interposed therebetween, and the at least one second phase compensation element is a pair of second phase compensation elements arranged so as to face each other with the liquid crystal cell interposed therebetween.

Preferably, the liquid crystal display device further includes a pair of third phase compensation elements respectively provided between the pair of second phase compensation elements and the pair of polarizing plates so as to face each other with the liquid crystal layer interposed therebetween, wherein each of the pair of third phase compensation elements has a slow axis extending parallel with an absorption axis of the polarizing plate located on the same side of the liquid crystal cell, and the pair of third phase compensation elements have approximately the same retardation.

The pair of first phase compensation elements preferably have approximately the same retardation, and the pair of second phase compensation elements preferably have approximately the same retardation.

Preferably, respective absorption axes of the pair of polarizing plates form an angle of about 45° with the respective orientation-axis directions of the first and second liquid crystal regions.

Preferably, the liquid crystal layer is a homogeneous orientation liquid crystal layer. Note that the liquid crystal layer may be a twisted orientation liquid crystal layer preferably having a twist angle less than 90°.

### BRIEF DESCRIPTION OF THE DRAWINGS

FIG. 1 is a diagram schematically showing a single picture element of an LCD 100 according to an embodiment of the present invention;

FIG. 2 is a diagram schematically showing a single picture element of another LCD 200 according to an embodiment of the present invention;

FIG. 3 is a diagram schematically showing a single picture element of still another LCD 300 according to an embodiment of the present invention;

FIG. 4 is a diagram schematically showing a single picture element of yet another LCD 400 according to an embodiment of the present invention;

FIG. 5 is a diagram schematically showing a liquid crystal layer 120 of an LCD according to an embodiment of the present invention in the presence of an applied voltage;

FIG. 6 is a diagram schematically showing a liquid crystal cell 102 of an LCD according to an example of the present invention; and

FIG. 7 is a graph showing gray-scale viewing-angle characteristics of an LCD according to an example of the present invention.

### DETAILED DESCRIPTION OF THE PREFERRED EMBODIMENTS

Hereinafter, the structure and operation of the LCDs according to the embodiments of the present invention will be described with reference to the accompanying drawings. For simplicity, components such as substrates, electrodes and alignment films are omitted in the figures described below. The arrows in the figures described below represent a slow axis or fast axis of a phase compensation element, and an absorption axis of a polarizing plate.

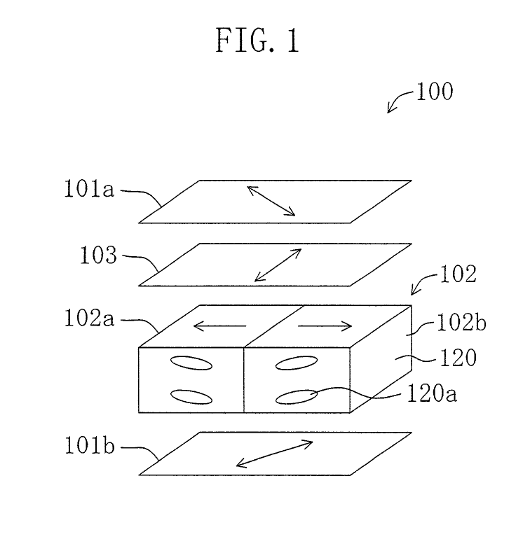

FIG. 1 schematically shows a single picture element of an LCD 100 according to an embodiment of the present invention.

The LCD 100 includes a liquid crystal cell 102, a pair of polarizing plates 101a and 101b facing each other with the liquid crystal cell 102 interposed therebetween, and a first phase compensation element 103 provided between the liquid crystal cell 102 and the polarizing plate 101a.

The liquid crystal cell 102 includes a horizontal orientation liquid crystal layer 120. The horizontal orientation liquid crystal layer 120 includes liquid crystal molecules 120a having a positive dielectric anisotropy. The liquid crystal layer is a layer that is provided between a pair of substrates of the liquid crystal cell 102 arranged so as to face each other, and that extends in parallel with the substrate surface (display plane).

The horizontal orientation liquid crystal layer refers to a liquid crystal layer in which the liquid crystal molecules are oriented with their major axes extending in parallel with the substrate surface (which typically has an alignment film thereon) in the absence of an applied voltage. It should be noted that the liquid crystal molecules in this liquid crystal layer are not oriented in parallel with the substrate in the strict sense, but are pre-tilted in order to define the direction in which the liquid crystal molecules are raised. The pre-tilt angle is greater than 0° and smaller than 45°. Practically, the pre-tilt angle is in the range of 1° to 10°. Specific examples of the horizontal orientation liquid crystal layer include a TN orientation liquid crystal layer and a homogeneous orientation liquid crystal layer having alignment films rubbed in the antiparallel directions. Note that, in the specification, a liquid crystal layer in which the liquid crystal molecules have a twist angle of zero degree in the initial orientation state is referred to as a homogeneous orientation liquid crystal layer.

In response to a voltage applied from a pair of electrodes facing each other with the liquid crystal layer interposed therebetween, the orientation direction of the liquid crystal molecules in the liquid crystal layer is changed, thereby modulating the light passing through the liquid crystal layer (i.e., changing the polarization direction). The pair of electrodes define a picture element of the liquid crystal cell. For simplicity, a region of the liquid crystal cell corresponding to the minimum display unit, i.e., a “picture element”, is also herein referred to as a “picture element”. For example, in the active-matrix LCD, a picture-element electrode and a counter electrode facing the same define a picture element. In the simple-matrix LCD, an intersection of a stripe-shaped column electrode (signal electrode) and row electrode (scanning electrode) defines a picture element.

Each picture element of the liquid crystal cell 102 includes first and second liquid crystal regions 102a and 102b. The respective orientation-axis directions of the first and second liquid crystal regions 102a and 102b form an angle of 170° to 190° with each other. The orientation-axis direction is defined by an azimuth of the orientation direction of the liquid crystal molecules 120a located in the center of the liquid crystal layer 120 in the thickness direction. The liquid crystal cell 102 has a so-called multi-domain structure. Preferably, the angle between the respective orientation-axis directions of the first and second liquid crystal regions 102a and 102b is approximately 180°. When these orientation-axis directions are displaced with respect to each other by more than 10° from 180° (i.e., a parallel or linear state), the viewing-angle characteristics become asymmetric, thereby degrading the display quality.

The arrows shown in the first and second liquid crystal regions 102a and 102b of FIG. 1 indicate the respective orientation-axis directions. In view of the pre-tilt direction of the liquid crystal molecules 120a, the arrowhead of the orientation-axis direction indicates the direction in which the liquid crystal molecules 120a are raised. The arrows indicating the respective orientation-axis directions of the liquid crystal regions 102a and 102b herein point in the opposite directions with respect to the boundary between the liquid crystal regions, based on the lower side of the liquid crystal cell 102. However, the liquid crystal regions 102a and 102b may alternatively be formed such that the arrows point to the boundary with their arrowheads facing each other (this is equivalent to the orientation-axis directions being indicated based on the upper side of the liquid crystal cell 102). Although the arrows indicating the respective orientation-axis directions of the liquid crystal regions 102a and 102b are herein at right angles with the boundary between the regions 102a and 102b, the angle between the orientation-axis direction and the boundary is not limited to this. The orientation-axis direction may be at any angle with the boundary as long as the angle between the respective orientation-axis directions of the liquid crystal regions is in the range of 170° to 190°.

Although the homogeneous liquid crystal layer 120 are herein exemplified in which the liquid crystal molecules 120a are oriented in parallel with each other in the thickness direction of the liquid crystal layer 120, a twisted orientation liquid crystal layer may alternatively be used. The use of the twisted orientation liquid crystal layer slightly reduces the viewing-angle characteristics, but improves the orientation stability, thereby suppressing unevenness of the initial orientation. This increases a production margin, whereby mass production capability of the LCD is improved. In this case as well, the orientation-axis direction is defined by an azimuth direction of the liquid crystal molecules located in the center of the liquid crystal layer in the thickness direction. Note that, in order to obtain a sufficiently high response speed, and for easy compensation for a retardation by a phase compensation element, the twist angle is preferably less than 90°, more preferably 20° or less, and most preferably 0° (i.e., homogeneous orientation).

Each picture element may include a plurality of first liquid crystal regions 102a and a plurality of second liquid crystal regions 102b. It should be noted that, in order to obtain symmetric viewing-angle characteristics, it is preferable that the first and second liquid crystal display regions 102a and 102b have an area ratio of 1:1 and are arranged symmetrically. The shape of the liquid crystal regions 102a and 102b is not particularly limited, but an approximately rectangular shape, i.e., a shape resulting from dividing a picture element into two or four regions by a straight line, is preferable. This shape allows for division of the picture element by means of a simple mask, and also can minimize the length of the boundary portion between the first and second liquid crystal regions 102a and 102b, i.e., the portion causing light scattering. In order to improve the contrast ratio, a black matrix for blocking the scattered light may be provided corresponding to the boundary portion between the first and second liquid crystal regions 102a and 102b. The contrast ratio can also be improved in a display device in which a plurality of picture elements form a single display dot (display pixel). In either case, alternate arrangement of the first and second liquid crystal regions 102a and 102b in a checkered or striped pattern enables highly uniform display in various azimuth directions.

The first and second liquid crystal regions 102a and 102b can be formed according to various methods known as socalled orientation division methods. For example, the following methods can be used: combination of a rubbing method and an optical tilt control method (a method for site-selectively changing a tilt angle by light radiation; a mask rubbing method (a method for repeatedly conducting the steps of: forming a mask on an alignment film so as to expose the surface of the alignment film in a prescribed pattern; and selectively rubbing the exposed surface); and an optical orientation control method (a method for site-selectively controlling the orientation direction by light radiation).

The pair of polarizing plates 101a and 101b face each other with the liquid crystal cell 102 interposed therebetween. The first phase compensation element 103 is provided between the liquid crystal cell 102 and the polarizing plate 101a. These components are arranged such that the LCD 100 provides display in the normally white mode (NW mode). The phase compensation element 103 serves to compensate for a retardation of the liquid crystal layer 120 with respect to the vertical incident light on the liquid crystal layer 120. As shown in the figure, the pair of polarizing plates 101a and 101b are typically arranged such that the respective absorption axes (the axes perpendicular to the respective polarization axes) are perpendicular to each other (so-called crossed Nicols arrangement). The first phase compensation element 103 has a slow axis within the plane parallel to the liquid crystal layer 120. The first phase compensation element 103 is arranged such that the slow axis thereof is approximately perpendicular to the respective orientation-axis directions of the first and second liquid crystal regions 102a and 102b.

Functionality of the first phase compensation element in the LCD 100 will be described in more detail.

The liquid crystal molecules 120a in the first and second liquid crystal regions 102a and 102b are respectively raised in the opposite directions in response to application of an electric field. Therefore, the liquid crystal molecules 120a in the first and second liquid crystal regions 102a and 102b mutually compensate for the viewing-angle dependency of the display quality upon viewing the display plane of the LCD 100 obliquely with respect to the direction normal to the display plane, i.e., obliquely toward the orientation-axis direction. This suppresses inversion of the contrast ratio in an intermediate gray-scale display state. The viewing-angle dependency of the display quality in the first and second liquid crystal regions 102a and 102b is symmetric with respect to the direction normal to the display plane. Therefore, the display quality is the highest in the direction normal to the display plane.

When a sufficiently high voltage is applied to the liquid crystal layer 120, the liquid crystal molecules 120a having a positive dielectric anisotropy are oriented substantially vertically to the substrate surface. Therefore, the liquid crystal layer 120 has a very small retardation when viewed in the direction normal to the substrate. As a result, the light hardly transmits through the polarizing plates 101a and 101b arranged in the crossed Nicols state, thereby providing black display.

However, the liquid crystal molecules 120a located near the surface of the alignment film has been subjected to strong orientation regulation force (anchoring effect) of the alignment film. Therefore, orientation of these liquid molecules 120a does not change at about 5 V, a voltage used in a normal active matrix LCD. In other words, even when a voltage for black display is applied, some liquid crystal molecules 120a are kept in parallel with the substrate surface. These liquid crystal molecules 120a exhibit a finite (non-zero) retardation with respect to the vertical incident light on the liquid crystal layer 120. This retardation is called residual retardation, and the magnitude thereof is mostly in the range of about 20 nm to about 50 nm, while depending on a liquid crystal materiall. The residual retardation causes light leakage in the black display state (degradation in black display level), thereby reducing the contrast ratio.

The first phase compensation element 103 is provided in order to compensate for this residual retardation. The first phase compensation element 103 has a slow axis within the plane parallel with the liquid crystal layer 120, and is arranged such that the slow axis is approximately perpendicular to the respective orientation-axis directions of the first and second liquid crystal regions 102a and 102b. Setting the retardation of the phase compensation element 103 to an approximately the same value as the residual retardation makes it possible to compensate for the residual retardation of the liquid crystal layer 120 in the black display state. Thus, the light leakage in the black display state can be suppressed.

The liquid crystal layer 120 has been divided in terms of the orientation so that every picture element has the first and second liquid crystal regions 102a and 102b. However, since the respective orientation-axis directions (corresponding to the slow axes) of the liquid crystal regions 102a and 102b are approximately parallel with each other (180°±10°), the liquid crystal regions 102a and 102b exhibit a uniaxial optical anisotropy. Accordingly, the first phase compensation element having a slow axis within the plane parallel with the liquid crystal layer 120 and arranged such that the slow axis is approximately perpendicular to the respective orientation-axis directions of the first and second liquid crystal regions can effectively compensate for the optical anisotropy (retardation) of the liquid crystal layer 120. In other words, in order to effectively compensate for the residual retardation by using the first phase compensation element 103, it is preferable that the homogeneous orientation liquid crystal layer 120 is divided into the liquid crystal regions 102a and 102b such that the angle between the respective orientation-axis directions is about 180°.

Any element may be used as the first phase compensation element 103 as long as it is transparent and has a uniform in-plane retardation. For example, a phase film (also called a phase plate) such as polymer stretch film and liquid crystal film may be used. The same applies to other phase compensation elements described below.

The polarizing plates 101a and 101b are preferably arranged such that their respective absorption axes form an angle of approximately 45° with the respective orientationaxis directions of the first and second liquid crystal regions 102a and 102b. The brightness in the white display state of the NW-mode LCD 100 is maximized when the retardation of the liquid crystal layer 120 in the absence of an applied voltage is approximately half the wavelength of about 550 nm corresponding to the highest human eye's color sensitivity (i.e., about 275 nm).

As described above, the LCD 100 has a multi-domain structure, and compensates for the retardation by using a phase compensation element. Therefore, the LCD 100 has a wider viewing angle than a conventional TN-mode LCD. Moreover, the LCD 100 employs a homogenous orientation liquid crystal layer or a twisted liquid crystal layer having a twist angle less than 90°. Therefore, the LCD 100 has a higher response speed than the TN-mode LCD having a twist angle of about 90° (the response time of 16.7 msec or less can be realized). Furthermore, the LCD 100 provides display in the NW mode by using a horizontal orientation liquid crystal layer including a liquid crystal material having a positive dielectric anisotropy. Therefore, the LCD 100 provides the white display as bright as that of the TN-mode LCD (the display brightness is about 1.5 times that of the normally black mode (NB mode)). The LCD 100 exemplified herein is capable of realizing high-quality display having a contrast ratio of 300 or more in the direction normal to the display plane (this contrast ratio is also referred to as a frontal contrast ratio).

An NB-mode LCD using a vertical orientation liquid crystal layer that includes a liquid crystal material having a negative dielectric anisotropy is likely to have noticeable unevenness of the display in an intermediate gray-scale display state close to black. The reason for this is as follows: the NB-mode LCD has steep voltage-transmittance characteristics and a narrow display voltage margin in the aforementioned display state. In addition, negligible unevenness of the alignment film and cell thickness is likely to result in noticeable unevenness of the display in this display state. Accordingly, this NB-mode LCD has a narrow production margin, and is problematic in terms of the mass production capability. In contrast, the LCD 100 does not cause such unevenness of the display, and has a production margin equivalent to that of the TN-mode LCD. Accordingly, the LCD 100 can be mass-produced according to the standard equivalent to that of the conventional TN-mode LCD. In other words, the same manufacturing process and examination standard can be applied without reducing the margin of design parameters and process parameters of the conventional TN-mode LCD, causing no increased costs resulting from change in the manufacturing and examination processes and reduction in yield. Accordingly, a wide viewing-angle LCD that is less expensive than the IPS mode and MVA mode can be provided.

Degradation in display quality is observed when the LCD 100 is viewed obliquely with respect to its surface. Such degraded display quality results from the retardation that cannot completely be compensated for just by the first phase compensation element 103 having a retardation in the horizontal direction (the in-plane direction of the liquid crystal layer 120). Compensating for this retardation enables further improvement in the viewing-angle dependency of the display quality of the LCD 100.

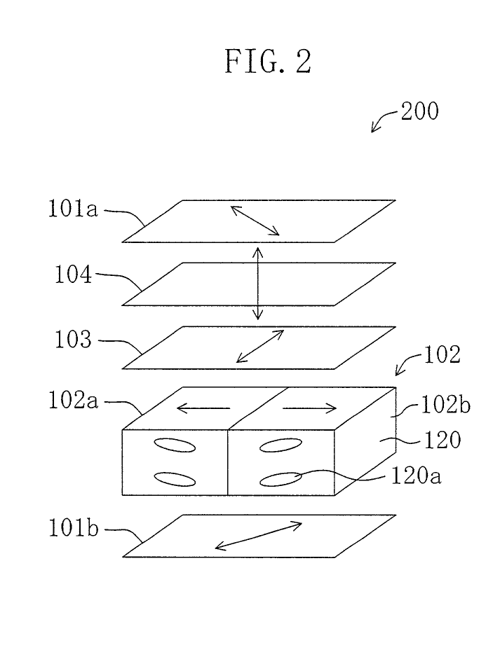

FIG. 2 schematically shows a single picture element of another LCD 200 according to an embodiment of the present invention. The LCD 200 includes a second phase compensation element 104 in addition to the components of the LCD 100. The same components as those of the LCD 100 are denoted with the same reference numerals and characters, and description thereof will be omitted herein.

As shown in FIG. 2, the LCD 200 includes the second phase compensation element 104 between the first phase compensation element 103 and the polarizing plate 101a. Provided that the second phase compensation element 104 has a principal refractive index nz in the direction perpendicular to the plane of the liquid crystal layer 120 (the direction normal to the liquid crystal layer), and two principal refractive indices nx and ny in the in-plane direction of the liquid crystal layer, the second phase compensation element 104 is represented by an index ellipsoid of nz <nx and nz <ny. In other words, the second phase compensation element 104 has a fast axis in the direction normal to the liquid crystal layer 120 as shown by the arrow in the figure, and has a negative retardation in the fast-axis direction. The magnitude of the retardation in the fast-axis direction is determined as the difference between the retardation of the liquid crystal cell 102 and the first phase compensation element 103 in the in-plane direction of the liquid crystal layer 120 (referred to as “in-plane retardation”) and the retardation of the liquid crystal cell 102 in the direction normal to the liquid crystal layer (referred to as “vertical retardation”).

By compensating for the vertical retardation of the liquid crystal layer 120 using the second phase compensation element 104, the retardation anisotropy at an oblique viewing angle with respect to the normal line to the display plane can be uniformly compensated for at almost all viewing angles except the orientation-axis directions of the first and second liquid crystal regions. This suppresses degradation in display quality resulting from incomplete retardation compensation by the first phase compensation element 103 alone. As a result, excellent black display can be realized as a whole. In the case where the polarizing plates 101a and 101b have a vertical retardation, the retardation of the second phase compensation element 104 need only be set so as to compensate also for the respective retardations of the polarizing plates 101a and 101b.

In the foregoing description, the first and second phase compensation elements 103 and 104 are provided only on the viewer side of the liquid crystal cell 102 (the upper side of the figure). However, equivalent characteristics will be obtained even when the first and second phase compensation elements 103 and 104 are provided on the light source side of the liquid crystal cell 102 (the lower side of the figure).

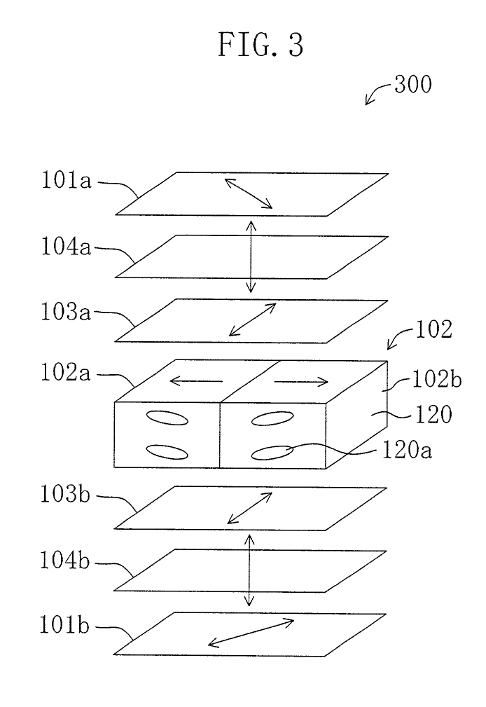

As in the LCD 300 of FIG. 3, first phase compensation elements 103a, 103b and second phase compensation elements 104a, 104b may alternatively be provided so as to face each other with the liquid crystal cell 102 interposed therebetween. In this case, the first phase compensation elements 103a, 103b and the second phase compensation elements 104a, 104b are provided so that the total retardation of the first phase compensation elements 103a and 103b corresponds to the preset retardation of the first phase compensation element 103 as well as the total retardation of the second phase compensation elements 104a, 104b corresponds to the preset retardation of the second phase compensation element 104. It is preferable that the first phase compensation elements 103a and 103b have equal optical characteristics and the second phase compensation elements 104a and 104b also have equal optical characteristics. It is difficult to adjust the magnitude of birefringence and the wavelength dependency of a phase compensation element and to produce a phase compensation element having a large retardation in the vertical direction. Therefore, the first phase compensation elements 103a, 103b and the second phase compensation elements 104a, 104b are each preferably produced from the same polymer film.

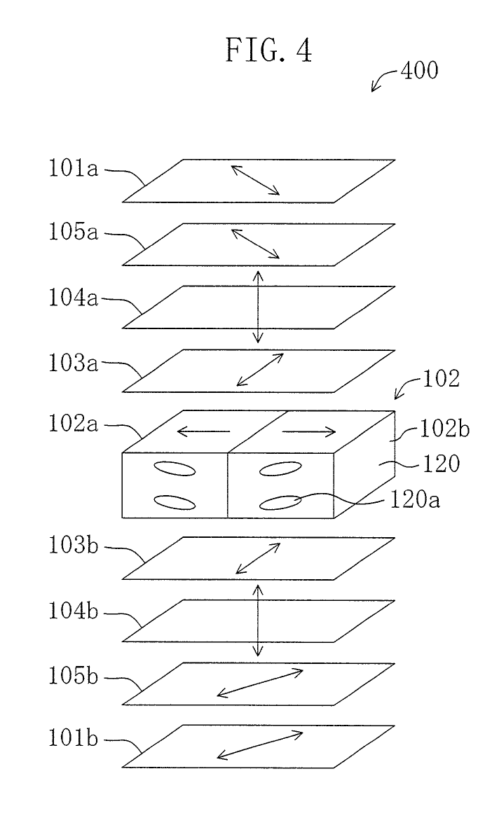

When an azimuth of the viewing direction is changed with respect to the display plane of the LCD 200 or 300, an apparent angle between the absorption axes of the polarizing plates 101a and 101b varies accordingly. Therefore, in the black display state, light leakage is observed at an oblique viewing angle (i.e., when the LCD is viewed obliquely with respect to the normal line to the display plane). This light leakage is effectively prevented by providing third phase compensation elements 105a and 105b directly inside the respective polarizing plates 101a and 101b (i.e., on the side of the liquid crystal cell 102) as in the LCD 400 of FIG. 4. In this case, each of the third phase compensation elements 105a and 105b has a slow axis approximately parallel with the absorption axis of the corresponding polarizing plate 101a, 101b.

The third phase compensation elements 105a and 105b rotate the principal axis of elliptically polarized light incident on the polarizing plate 101a of the viewer side through the liquid crystal layer 120, thereby preventing light leakage in the black display state resulting from a change in the viewing angle. The third phase compensation element compensates for a retardation anisotropy in the frontal viewing direction. Therefore, it is preferable to provide the third phase compensation elements 105a and 105b having the same retardation on both sides of the liquid crystal cell 102b.

The aforementioned phase compensation elements (first, second and third phase compensation elements) need not be individually formed from a single phase compensation element (typically, a single phase film). For example, a single phase compensation element having both functions of the first and second phase compensation elements may be used instead of the first and second phase compensation elements. Alternatively, each of the first, second and third phase compensation elements may be formed from lamination of a plurality of phase compensation elements (typically, phase films).

The liquid crystal cell 102 having the horizontal orientation liquid crystal layer 120 can be produced with a known material by a known method. In order to obtain high display quality, it is desirable to use a light-shielding spacer as a spacer for cell-gap control of the liquid crystal cell 102 or to selectively dispose a spacer in the black matrix portion of the liquid crystal cell 102. When a transparent spacer is present within a picture element, the light transmitted through the spacer travels through an optical path having a refractive index anisotropy due to the first phase compensation element. Therefore, a certain amount of light is always transmitted, resulting in light leakage in the black display state. Thus, the contrast ratio is reduced.

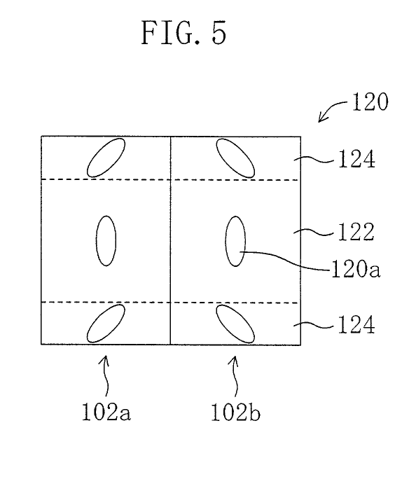

Note that the LCD 400 has excellent display quality, but causes light leakage in the presence of an applied voltage (the black display state). This phenomenon will now be described with reference to FIG. 5. FIG. 5 schematically shows the state where a voltage for black display is applied to the liquid crystal layer 120 of the liquid crystal cell 102.

The liquid crystal layer 120 includes an intermediate layer 122 having the orientation direction varied arbitrarily according to the applied voltage, and liquid crystal layers (hereinafter, referred to as “anchoring layers”) 124 located near the respective alignment films (not shown) and causing the residual retardation. The liquid crystal molecules 120a in the intermediate layer 122 are oriented approximately vertically to the substrates (not shown). In the first and second liquid crystal regions 102a and 102b having their respective orientation-axis directions being different from each other by about 180°, the liquid crystal molecules 120a in each anchoring layer 124 have been raised in the directions different from each other by 180° (which are the same as the pre-tilt directions and the orientation-axis directions).

Thus, the liquid crystal molecules 120a in the anchoring layer 124 are oriented in the different directions in the liquid crystal layers 102a and 102b. Therefore, when the liquid crystal layers 102a and 102b are viewed obliquely during application of an electric field, the respective apparent residual retardations of the liquid crystal regions 102a and 102b necessarily have different magnitudes and directions. In other words, it is impossible to completely and simultaneously compensate for the respective residual retardations of the liquid crystal regions 102a and 102b when the LCD is viewed obliquely. As a result, light leakage occurs accordingly, thereby reducing the contrast ratio. This light leakage is maximized when the LCD is viewed from the direction parallel with the slow axis of the residual retardation (i.e., from the orientation-axis direction).

For example, the light leakage resulting from incompleteness of the retardation compensation by the orientation division can be reduced by using the lens film method described in Japanese Laid-Open Publication No. 6-27454. As described in this publication, by providing a concavo-convex lens array sheet such as a lenticular lens in the LCD 400 so as to widen the viewing angle in a single direction, degradation in display quality resulting from the light leakage can be suppressed.

A specific example of the LCD 400 of FIG. 4 will now be described.

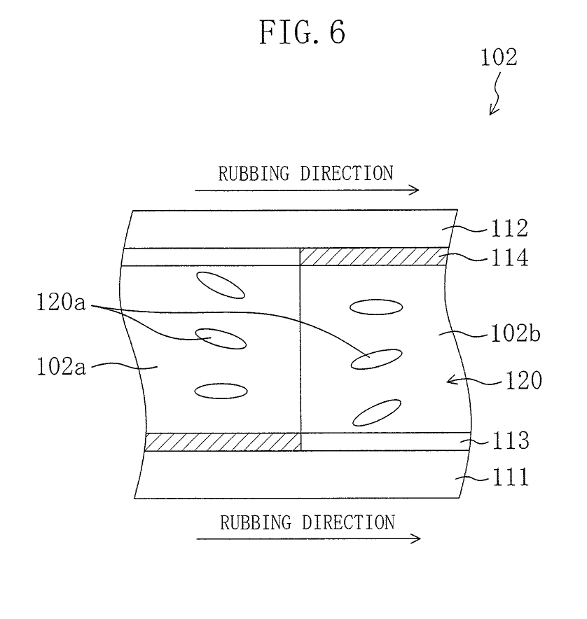

The structure of the liquid crystal cell 102 of the LCD 400 and the manufacturing method thereof will now be described with reference to FIG. 6. FIG. 6 schematically shows a single picture element of the liquid crystal cell 102.

Herein, a TFT (Thin Film Transistor) liquid crystal cell 102 was produced in the following manner:

First, a TFT substrate 111 and a color filter substrate 112 are produced according to a known method. Polyimide alignment films 113 and 114 are formed on the respective surfaces of the substrates 111 and 112 facing the liquid crystal layer 120. The liquid crystal cell is, e.g., an 18-inch liquid crystal cell.

Deep UV (Ultra Violet rays) is radiated to the alignment films 113 and 114 using a stripe-shaped mask having half a pitch of the picture elements. The hatched portion of FIG. 6 represents a region subjected to the selective deep-UV radiation. Thereafter, the alignment films 113 and 114 are rubbed with, e.g., a rayon-based cloth. The TFT substrate 111 and the color filter substrate 112 are then laminated each other with a gap of about 4 μm therebetween. More specifically, the TFT substrate 111 and the color filter substrate 112 are laminated with the alignment films 113 and 114 facing each other so as to have the same rubbing direction as shown by the arrows in FIG. 6. At this time, the TFT substrate 111 and the color filter substrate 112 are aligned such that the UV-radiated region of one substrate exactly faces the non-radiated region of the other. A light-shielding spacer and a non-chiral liquid crystal material having a birefringence Δn of 0.065 are used.

The pre-tilt angle is almost 0° at the interface with the UV-radiated region (the hatched portion) of the alignment films 113 and 114, but is about 4° at the interface with the non-radiated region thereof. Since the upper and lower substrates 111 and 112 are arranged such that the UV-radiated region of one substrate faces the non-radiated region of the other. Therefore, as shown in FIG. 6, the direction in which the liquid crystal molecules 120a located in the center of the liquid crystal layer 120 in the thickness direction are raised is different by about 180° between the first and second liquid crystal regions 102a and 102b.

The liquid crystal layer 120 of the liquid crystal cell 102 thus obtained has a retardation of about 260 nm in the absence of an applied voltage. When a driving voltage of 5 V (black display) is applied, the liquid crystal layer 120 exhibits the maximum retardation (residual retardation) of about 70 nm in the rubbing direction.

In order to compensate for this residual retardation, phase films each having a retardation of about 35 nm are provided as the first phase compensation elements 103a and 103b. These phase films are provided on both surfaces of the liquid crystal cell 102 such that the respective slow axes are perpendicular to the rubbing direction.

In the presence of an applied voltage (5 V), the liquid crystal layer 120 has a vertical retardation of about 250 nm. Each of the polarizing plates 101a and 101b has a negative retardation of about 50 nm in the vertical direction. In order to compensate for the vertical retardation, phase films each having a negative retardation of about 40 nm in the vertical direction are provided on both sides of the liquid crystal cell 102 as the second phase compensation elements 104a and 104b. By compensating for the vertical retardation as such, the total vertical retardation becomes about 70 nm (about 250 nm-about 50×2-about 40 nm×2), whereby the black display having no three-dimensional anisotropy on the average can be implemented.

Moreover, uniaxial phase films each having an in-plane retardation of about 140 nm are provided as the third phase compensation elements 105a and 105b. These uniaxial phase films are provided directly inside the respective polarizing plates 101a and 101b (i.e., on the side of the liquid crystal cell 102) such that their respective slow axes extend in parallel with the absorption axes of the polarizing plates 101a and 101b. Thus, the LCD 400 is obtained.

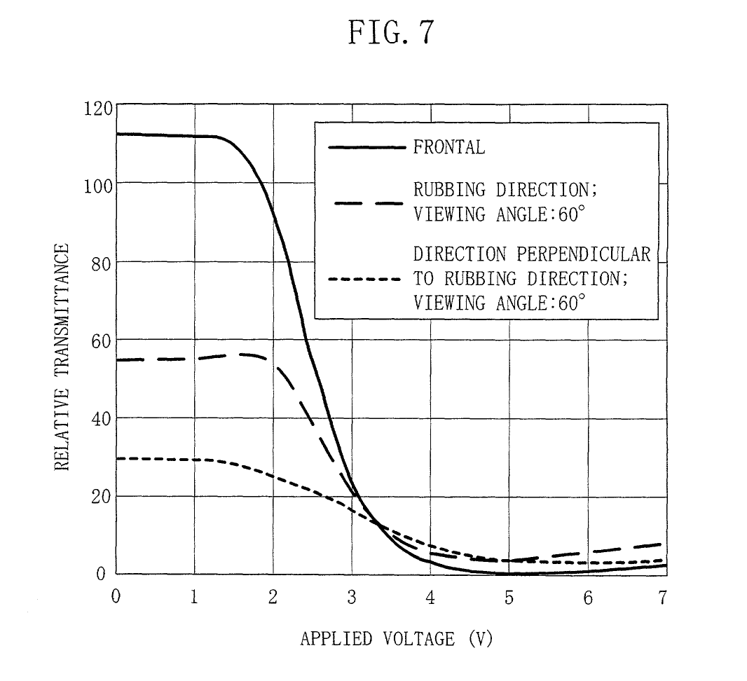

The voltage-transmittance characteristics of the LCD 400 are shown in FIG. 7. FIG. 7 shows the voltage-transmittance characteristics measured from three different viewing-angle directions. The three voltage-transmittance curves are: a curve (Frontal) measured from the direction normal to the display plane (the direction normal to the liquid crystal layer); a curve (Rubbing direction; viewing angle: 60°) measured from the direction tilted by 60° from the direction normal to the display plane along the rubbing direction (the orientation-axis direction) of the first and second liquid crystal regions 102a and 102b; and a curve (Direction perpendicular to rubbing direction; viewing angle: 60° measured from the direction tilted by 60° from the direction normal to the display plane along the direction perpendicular to the rubbing direction of the first and second liquid crystal regions 102a and 102b.

As can be seen from the voltage-transmittance curves of FIG. 7, in every viewing-angle direction, the transmittance is approximately monotonously reduced with increase in the applied voltage. Accordingly, the gray-scale inversion phenomenon resulting from the transmittance increasing with increase in the voltage does not occur within the voltage-transmittance curve. Moreover, in every viewing-angle direction, the transmittance starts decreasing at almost the same applied voltage and also reaches the minimum value at almost the same applied voltage. It is now assumed that the applied voltage is set to 2 V for white display and 5 V for black display. In this voltage range, the transmittance monotonously decreases with increase in the voltage in every viewing-angle direction. Accordingly, throughout the gray-level voltage range from 2 V to 5 V, the displayed image does not become blackish or whitish as a whole in any viewing-angle direction. Thus, in this voltage range, the LCD 400 provides approximately the same excellent image quality as that is obtained when the LCD 400 is viewed from the direction normal to the display plane. This LCD 400 has a frontal contrast ratio of 250 or more and a response speed of about 15 msec, thereby achieving excellent moving-picture display characteristics.

The LCD of the present invention has a multi-domain structure, and compensates for the retardation by using a phase compensation element. Therefore, the LCD of the present invention has a wider viewing angle than the conventional TN-mode LCD. Moreover, the LCD of the present invention employs a homogenous orientation liquid crystal layer or a twisted liquid crystal layer having a twist angle less than 90°. Therefore, the LCD of the present invention has a higher response speed than the conventional TN-mode LCD. Furthermore, the LCD of the present invention provides display in the NW mode by using a horizontal orientation liquid crystal layer including a liquid crystal material having a positive dielectric anisotropy. Therefore, the LCD of the present invention can realize the white display as bright as that of the TN-mode LCD. Moreover, the same manufacturing process and examination standard can be applied without reducing the margin of design parameters and process parameters of the conventional TN-mode LCD.

According to the LCD of the present invention, the light leakage in the black display state (degradation in black display level) in the frontal and oblique viewing-angle directions can be suppressed by using a phase compensation element. As a result, extremely high display quality with improved viewing-angle characteristics can be realized without causing the gray-scale inversion phenomenon.

Thus, an LCD having improved viewing-angle characteristics over the conventional TN mode, having a high response speed and also capable of being produced at relatively low costs is provided according to the invention. The LCD of the present invention is used preferably as wide viewing-angle liquid crystal televisions, and wide viewing-angle liquid crystal monitors for OA or CAD (Computer Aided Design) applications.

While the present invention has been described in a preferred embodiment, it will be apparent to those skilled in the art that the disclosed invention may be modified in numerous ways and may assume many embodiments other than that specifically set out and described above. Accordingly, it is intended by the appended claims to cover all modifications of the invention that fall within the true spirit and scope of the invention.

What is claimed is:

1. A liquid crystal display device, comprising:
a liquid crystal cell including a pair of substrates, and a horizontal orientation liquid crystal layer provided between the pair of substrates and including liquid crystal molecules having a positive dielectric anisotropy, the liquid crystal cell having a plurality. of picture elements, the picture elements each being defined by a pair of electrodes facing each other with the liquid crystal layer interposed therebetween;
a pair of polarizing plates provided outside the liquid crystal cell; and
at least one first phase compensation element provided between the liquid crystal cell and the pair of polarizing plates, the liquid crystal display device providing display in a normally white mode, wherein
each of the plurality of picture elements has first and second liquid crystal regions having their respective orientation-axis directions forming an angle of 170° to 190° with each other, the orientation-axis directions being defined by an azimuth of an orientation direction of the liquid crystal molecules located in a center of the liquid crystal layer in a thickness direction, and
the at least one first phase compensation element compensates for a retardation of the liquid crystal layer in a black display state with respect to vertical incident light on the liquid crystal layer.

2. The liquid crystal display device according to claim 1, wherein the pair of polarizing plates are arranged such that their respective absorption axes are perpendicular to each other, and the at least one first phase compensation element has a slow axis within a plane parallel with the liquid crystal layer and is arranged such that the slow axis is approximately perpendicular to the respective orientation-axis directions of the first and second liquid crystal regions.

3. The liquid crystal display device according to claim 1, further comprising at least one second phase compensation element between the pair of polarizing plates and the liquid crystal cell, the at least one second phase compensation element having a fast axis in a direction normal to the liquid crystal layer.

4. The liquid crystal display device according to claim 3, wherein the at least one second phase compensation element is provided between the at least one first phase compensation element and the pair of polarizing plates.

5. The liquid crystal display device according to claim 4, wherein the at least one first phase compensation element is a pair of first phase compensation elements arranged so as to face each other with the liquid crystal cell interposed therebetween, and the at least one second phase compensation element is a pair of second phase compensation elements arranged so as to face each other with the liquid crystal cell interposed therebetween.

6. The liquid crystal display device according to claim 5, further comprising a pair of third phase compensation elements respectively provided between the pair of second phase compensation elements and the pair of polarizing plates so as to face each other with the liquid crystal layer interposed therebetween, wherein each of the pair of third phase compensation elements has a slow axis extending parallel with an absorption axis of the polarizing plate located on the same side of the liquid crystal cell, and the pair of third phase compensation elements have approximately the same retardation.

7. The liquid crystal display device according to claim 6, wherein the pair of first phase compensation elements have approximately the same retardation.

8. The liquid crystal display device according to claim 6, wherein the pair of second phase compensation elements have approximately the same retardation.

9. The liquid crystal display device according to claim 1, wherein respective absorption axes of the pair of polarizing plates form an angle of about 45° with the respective orientation-axis directions of the first and second liquid crystal regions.

10. The liquid crystal display device according to claim 1, wherein the liquid crystal layer is a homogeneous orientation liquid crystal layer.

11. The liquid crystal display device according to claim 1, wherein the liquid crystal layer is a twisted orientation liquid crystal layer having a twist angle less than 90°.

12. The liquid crystal display device according to claim 2, further comprising at least one second phase compensation element between the pair of polarizing plates and the liquid crystal cell, the at least one second phase compensation element having a fast axis in a direction normal to the liquid crystal layer.

13. The liquid crystal display device according to claim 12, wherein the at least one second phase compensation element is provided between the at least one first phase compensation element and the pair of polarizing plates.

14. The liquid crystal display device according to claim 13, wherein the at least one first phase compensation element is a pair of first phase compensation elements arranged so as to face each other with the liquid crystal cell interposed therebetween, and the at least one second phase compensation element is a pair of second phase compensation elements arranged so as to face each other with the liquid crystal cell interposed therebetween.

15. The liquid crystal display device according to claim 14, further comprising a pair of third phase compensation elements respectively provided between the pair of second phase compensation elements and the pair of polarizing plates so as to face each other with the liquid crystal layer interposed therebetween, wherein each of the pair of third phase compensation elements has a slow axis extending parallel with an absorption axis of the polarizing plate located on the same side of the liquid crystal cell, and the pair of third phase compensation elements have approximately the same retardation.

16. The liquid crystal display device according to claim 15, wherein the pair of first phase compensation elements have approximately the same retardation.

17. The liquid crystal display device according to claim 15, wherein the pair of second phase compensation elements have approximately the same retardation.
